(19) United States
(12) Patent Application Publication
(10) Pub. No.: US 2023/0219852 A1
(43) Pub. Date: Jul. 13, 2023

(54) ELABORATION OF CERAMIC TILES MADE OF INDUSTRIAL SOLID WASTES

(71) Applicant: SERAMIC MATERIALS LIMITED, Abu Dhabi (AE)

(72) Inventors: Mike James TINER, Austin, TX (US); Jean-Francois HOFFMANN, (US)

(73) Assignee: SERAMIC MATERIALS LIMITED, Abu Dhabi (AE)

(21) Appl. No.: 18/043,503

(22) PCT Filed: Aug. 27, 2021
(86) PCT No.: PCT/US2021/047916

§ 371 Date: Feb. 28, 2023

(51) Int. Cl. C04B 33/138; C04B 33/14; C04B 33/132; C04B 33/04; C04B 33/32; C04B 33/30; C04B 33/24

(52) U.S. Cl. CPC C04B 33/138; C04B 33/14; C04B 33/1324; C04B 33/04; C04B 33/32; C04B 33/30; C04B 33/24; C04B 2235/349; C04B 2235/3418; C04B 2235/36; C04B 2235/6021

(57) ABSTRACT

A ceramic product and a method of producing the ceramic product produced by pretreating the feedstock from at least of iron/steel recovery, recovery of at least one non-ferrous material, sieving, crushing, milling, aging, and thermal treatment, receiving as a first powder a first recovered material from the pretreating, receiving as a second powder a second recovered material from the pretreating, combining the first and second powders with water to form at least one of an extrudable paste and a granulated mixture, forming a green body from the at least one of the extrudable paste after extrusion and the granulated mixture; drying the green body, firing the green body to form the ceramic product, and cooling the ceramic product.

### FIELD

The present disclosure is directed to ceramic tiles formed from recycled industrial solid wastes and the preparation method of manufacturing such a ceramic.

### BACKGROUND OF THE INVENTION

Due to their immense production volumes in the hundreds of millions tons per year, industrial mineral solid wastes are a growing concern, as most of them are currently landfilled or stockpiled on-site, potentially causing environmental and sanitary problems, and using useful land. Moreover, handling these enormous volumes of wastes increases overall production costs. These wastes include, but are not limited to: iron and steel dusts, alumina and aluminum red muds and dross, quarrying, mining and ceramic wastes and residues, combustion ashes (biomass or fossil fuels such as coal), refractory wastes, glass wastes, and municipal waste incineration ashes.

As most of these wastes streams are composed of alumina silicates, they might be advantageously recovered, treated and reused as feedstocks for the production of ceramic materials (Patent No. WO2007/126215A1, 2007; Patent No. US006342461B1, 2002; Patent No. US005521132A, 1996), with the added benefits of (i) saving conventional resources such as clay. (ii) saving the environmental potential impacts of ceramic feedstock extraction, (iii) potentially decreasing the operational costs of such ceramics production compared to conventional products, (iv) decreasing the need for landfilling installations.

Efforts have been made in the Research and Development community to develop ceramic formulations introducing these industrial wastes into conventional or innovative processes. However, most of these efforts did not make it to industrialization. The authors would like to expand on these works to propose an industrially sound and viable way to mass-produce waste-based ceramics.

### BRIEF DESCRIPTION OF THE DRAWINGS

FIG. 1 is flowchart showing a number of repeatable pre-treatment steps that may be applied to feedstocks prior to a number of the processing steps described herein.

FIG. 2 is a flowchart showing an extrusion technique for creating a ceramic product.

FIG. 3 is a flowchart showing a compaction technique for creating a ceramic product.

FIGS. 4A-4C are pictures showing exemplary tiles produced by at least one technique disclosed herein.

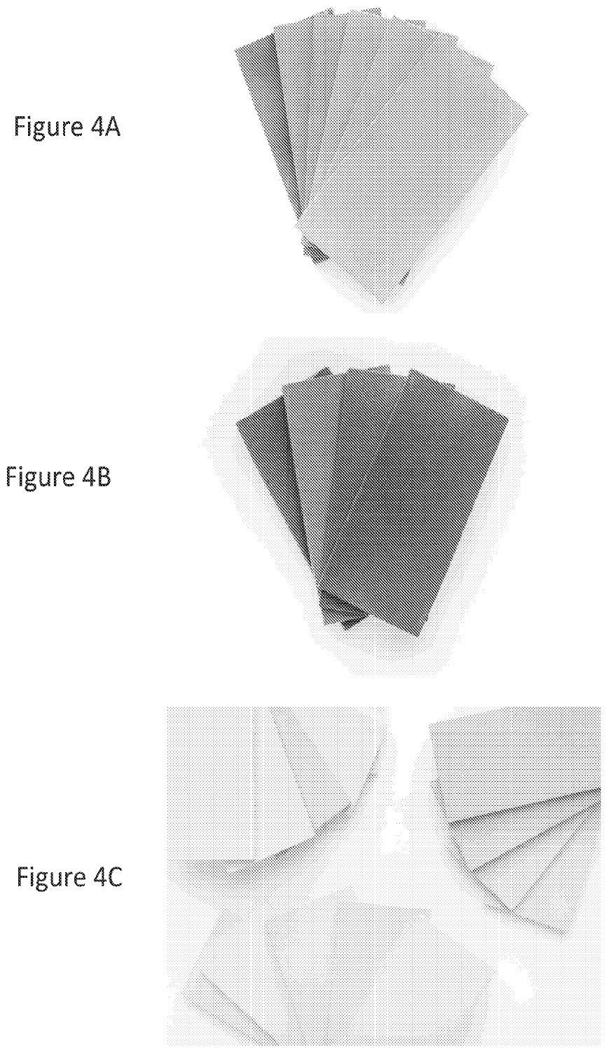

### DETAILED DESCRIPTION OF THE INVENTION

As noted in the field, the present disclosure is directed to ceramics tiles and a method of forming such ceramics from recycled industrial solid wastes and Unfired Ceramic Raw Materials (clay and clay-like materials). The present invention further related to two methods of forming the final products: (i) extrusion, and (ii) powder compaction process. The final products may be used in the fields of ceramic tiles, either as ceramic tiles, gres tiles, or porcelain tiles, depending on their final properties and national or international quality standards.

All materials that will not be destroyed during firing and will therefore be constituents of the final ceramic product will be thereafter designated as feedstocks, which exclude organic and water-based additives. Preferentially, the feedstocks are industrial solid wastes, or mixtures of industrial wastes. It is also possible to replace one industrial waste in the mixtures by a commercial material when the industrial waste is locally unavailable. There are several types of industrial waste recoverable from industrial processes, e.g., municipal waste incinerator, iron and steel industry, alumina and aluminum industry, biomass combustion, asbestos inertization, quarrying and mining, and ceramic industry.

The disclosed tile ceramics are produced based on:
(1) URCM comprises about 30 to about 95 wt. % of the mixture weight,
(2) at least one feedstock called “Chamotte” comprises about 5 to about 30 wt. % of the mixture weight included in the following list: Fired Ceramic Materials, Sand, Rock Dusts, Asbestos-containing wastes, and Refractory Wastes. The term Chamotte refers usually to crushed fired ceramics, used as a reinforcing agent for a new ceramic, as well as to reduce the firing shrinkage and the related deformations of the product (warping),
(3) at least one optional feedstock comprises about 0 to about 40 wt. % of the mixture weight included in the following list: MSWIBA, MSWIFA, Glass Waste, Alumina Red Mud, Aluminum Dross, Steelmaking dusts and Biomass Ash. These materials can either behave as fluxes, pigments or structural matrix, depending on the desired properties (esthetics and surface roughness),
(4) at least one optional commercial ceramic body color pigment comprises about 0 to about 5 wt. % of the mixture weight.

Preferentially, the ceramic feedstock will contain some weight percent of Clay or Clay-like. Clay is a finely-grained natural rock/soil material combining one or more clay minerals (hydrous aluminum phyllosilicates), often in combination with quartz and metal oxides, in variable proportions from one deposit to another (especially including clay-like minerals such as bauxite). They are usually plastic when hydrated, and become hard, brittle and non-plastic when dried or fired. Depending on the engineering field, clay-containing materials can also be called silts or muds as a function of particle size. Clay is one of the favorite ceramic industry's feedstocks, due to its good workability when wet. The clay-like used will be preferentially sourced from discarded material in the ceramic industry (dust, washing muds, surplus clay) or the mining and quarrying industries (dust and washing muds). Due to their waste nature, the muds and sludges can contain not only clay, but also ceramic fragments, glaze, sand and other impurities. The clay and clay-like materials are designated as Unfired Raw Ceramic Material (URCM). URCM comprises, and preferably consists essentially of:
aluminum oxide (Al₂O₃): from 12 to 71 wt. %,
calcium oxide (CaO): from 0 to 10 wt. %,
iron oxide (Fe₂O₃): from 1 to 15 wt. %,
magnesium oxide (MgO): from 0.01 to 10 wt. %,
silicon dioxide (SiO₂): from 6 to 71 wt. %,
sodium oxide (Na₂O): from 0.01 to 3 wt. %,
potassium oxide (K₂O): from 0.01 to 10 wt. %.
optionally one or more of the following: from 0.01 to 20 wt. %.
MnO, P₂O₅, SOx, and TiO₂
   and inevitable impurities, wherein the wt. % is the weight percent relative to the total weight of the URCM mineral composition to provide, including the inevitable impurities, 100 wt %. %. The inevitable impurities are, generally, unavoidable and are often a result of the process environment, feedstocks, or the natural deposit properties.

The ceramic formulation will contain some weight percent of MSWIBA. The Municipal waste incinerator is a waste treatment that involves the organic substances contained in municipal waste combustion. By high-temperature waste treatment, the incinerator converts the waste into ash, flue gas and heat. The ash is formed by inorganic constituents and may take the form of solid lumps (Municipal Solid Waste Incinerator Bottom Ash: MSWIBA) or particles carried by the flue gas (Municipal Solid Waste Incinerator Fly Ash: MSWIFA). The MSWIBA comprises, and preferably consists essentially of:
aluminum oxide (Al₂O₃): from 1 to 25 wt. %,
calcium oxide (CaO): from 3 to 60 wt. %,
iron oxide (Fe₂O₃): from 1 to 20 wt. %,
magnesium oxide (MgO): from 0.1 to 5 wt. %,
silicon dioxide (SiO₂): from 3 to 65 wt. %,
sodium oxide (Na₂O): from 1 to 25 wt. %,
potassium oxide (K₂O): from 0.5 to 10 wt. %,
optionally one or more of the following: from 0.01 to 20 wt. %.
MnO, P₂O₅, SOx, Cl, and TiO₂
   and inevitable impurities, wherein the wt. % is the weight percent relative to the total weight of the MSWIBA composition to provide, including the inevitable impurities, 100 wt. %. The inevitable impurities are, generally, unavoidable and are often a result of the process environment, feedstocks, or the process equipment. Inevitable impurities may be present from 0.01 to 20.0 wt. % of the composition.

About the municipal solid waste incinerator, the second waste generated is the MSWIFA in other words, the particles carried by the flue gas. MSWIFA composition can vary, depending on inlet garbage composition, process operations, and if the MSWIFA is mixed together with Air Pollution Control residues. The MSWIFA comprises, and preferably consists essentially of:
aluminum oxide (Al₂O₃): from 0.01 to 13 wt. %,
calcium oxide (CaO): from 19 to 47 wt. %,
iron oxide (Fe₂O₃): from 0.5 to 6 wt. %,
magnesium oxide (MgO): from 1 to 5 wt. %,
silicon dioxide (SiO₂): from 4 to 28 wt. %,
sodium oxide (Na₂O): from 1 to 10 wt. %,
potassium oxide (K₂O): from 2 to 9 wt. %,
Sulfates (SOx): from 4 to 15 wt. %
Chlorine and chlorates (Cl): from 0.5 to 25 wt. %
optionally one or more of the following: from 0.01 to 10 wt. %.
MnO, P₂O₅, and TiO₂
   and inevitable impurities, wherein the wt. % is the weight percent relative to the total weight of the MSWIFA composition to provide, including the inevitable impurities, 100 wt. %. The inevitable impurities are, generally, unavoidable and are often a result of the process environment, feedstocks, or the process equipment. Inevitable impurities may be present from 0.01 to 10.0 wt. % of the composition.

Waste glass, also known as glass cullet is mostly produced by household waste sorting. Waste glass is recycled in the glass primary production industry (container glass), although its introduction is limited. Sometimes, it is used as a fluxing agent in the ceramic industry. Their composition can vary depending on the glass type soda-lime or boron-silicate. These materials comprise, and preferably consists essentially of:
aluminum oxide (Al₂O₃): from 0.1 to 4 wt. %,
calcium oxide (CaO): from 4 to 10 wt. %,
magnesium oxide (MgO): from 1 to 7 wt. %,
silicon dioxide (SiO₂): from 65 to 80 wt. %,
sodium oxide (Na₂O): from 10 to 20 wt. %,
potassium oxide (K₂O): from 0.5 to 6 wt. %,
optionally one or more of the following: from 0.01 to 5 wt. %.
Fe₂O₃, MnO, and K₂O
   and inevitable impurities, wherein the wt. % is the weight percent relative to the total weight of the glass waste composition to provide, including the inevitable impurities, 100 wt. %. The inevitable impurities are, generally, unavoidable and are often a result of the process environment or feedstocks. Inevitable impurities may be present from 0.01 to 5.0 wt. % of the composition.

The steelmaking process is divided into two main stages: production of primary steel, then secondary refining of the steel to obtain the desired steel grade. There are two modern techniques for primary steelmaking: blast furnace (BF) process and electric arc furnace (EAF) process. During the steelmaking process, dust will be released, either mechanically due to the gas flow in the furnace or chemically due to volatilization, which are generally collected in a fumes treatment system. The dusts consists mainly of iron oxides, manganese oxide, silicates and lime. It will also contain other metals originating from incoming materials, e.g., Cr, Ni, Pb, Zn, Hg, etc. The composition of the dust may vary considerably depending on the steel making process, the presence of the scrap, and the forming substances added into the melt. These dusts are generally named after the process generating them (as an example, an Electric Arc Furnace generates EAF dusts). Special steels typically refer to Inox, vanadium-enriched, refractory steels (high Nickel content). Such alloys are produced by using special ores in processes similar to the EAF and Blast furnaces. The most known are Ferrochrome, Ferromanganese, Silicomanganese. These dusts can also be considered as steelmaking wastes. All the aforementioned wastes are hereinafter referred to as “Steelmaking dusts”.

Alumina red mud (ARM) or bauxite residue is the by-product of alumina production with the Bayer process. It consists in a fine clay-like powder, mixed with a strongly alkaline solution (Sodium Hydroxide) to form a mud. Its composition can vary, depending on the composition of the Bauxite deposit processed. The alumina industry usually filter-presses the ARM to recover the alkali solution and reuse it in the Bayer process. ARM is usually stored on-site in mud ponds and dams. ARM comprises, and preferably consists essentially of:
aluminum oxide (Al₂O₃): from 10 to 30 wt. %,
calcium oxide (CaO): from 0.5 to 45 wt. %,
iron oxide (Fe₂O₃): from 3 to 60 wt. %,
silicon dioxide (SiO₂): from 3 to 56 wt. %,
sodium oxide (Na₂O): from 2 to 10 wt. %,
potassium oxide (K₂O): from 0.01 to 4 wt. %,
optionally one or more of the following: from 0.01 to 20 wt. %.
MgO, MnO, P₂O₅, SOx, and TiO₂
   and inevitable impurities, wherein the wt. % is the weight percent relative to the total weight of the ARM composition to provide, including the inevitable impurities, 100 wt. %. The inevitable impurities are, generally, unavoidable and are often a result of the process environment, feedstocks, or the natural deposit properties. Inevitable impurities may be present from 0.01 to 20.0 wt. % of the composition.

There are two types of aluminum smelting (i) primary, and (ii) secondary. The primary aluminum is produced by electrolysis from alumina dissolved in cryolite (Hall Heroult process). On the other hand, the secondary aluminum comes from recycling aluminum-bearing scrap, which is recovered from some items and parts at the end of their useful life. The co-product obtained from primary smelting operations is called white dross. The dross from the secondary smelting operations is called black dross. Their composition can vary depending on the purity of the aluminum input, process operations and the use of slag-forming components added into furnace to help separate aluminum from impurities. The dross comprises, and preferably consists essentially of:
aluminum oxide (Al₂O₃): from 60 to 80 wt. %,
calcium oxide (CaO): from 0.01 to 5 wt. %,
iron oxide (Fe₂O₃): from 0.01 to 5 wt. %,
magnesium oxide (MgO): from 0.01 to 7 wt. %,
silicon dioxide (SiO₂): from 0.5 to 10 wt. %,
sodium oxide (Na₂O): from 0.01 to 9 wt. %.
potassium oxide (K₂O): from 0.01 to 4 wt. %.
optionally one or more of the following: from 0.01 to 20 wt. %.
MnO, P₂O₅, SOx, and TiO₂
   and inevitable impurities, wherein the wt. % is the weight percent relative to the total weight of the dross composition to provide, including the inevitable impurities, 100 w. %. The inevitable impurities are, generally, unavoidable and are often a result of the process environment or feedstocks. Inevitable impurities may be present from 0.01 to 20.0 wt. % of the composition.

Biomass combustion residues consists in Biomass Bottom Ash (BBA) and Biomass Fly Ash (BFA). Their composition can vary widely depending of the biomass' nature, process operations and eventual secondary feedstocks used as fuel (plastics, papers, etc.). The ashes (bottom ash and fly ash) comprise, and preferably consist essentially of:
aluminum oxide (Al₂O₃): from 0.01 to 10 wt. %,
calcium oxide (CaO): from 0.01 to 70 wt. %,
iron oxide (Fe₂O₃): from 0.01 to 4 wt. %,
magnesium oxide (MgO): from 0.01 to 12 wt. %,
silicon dioxide (SiO₂): from 3 to 95 wt. %,
potassium oxide (K₂O): from 0.01 to 48 wt. %,
phosphorous oxide (P₂O₅): from 0.01 to 22 wt. %,
optionally one or more of the following: from 0.01 to 10 wt. %.
MnO, SOx, and TiO₂
   and inevitable impurities, wherein the wt. % is the weight percent relative to the total weight of the biomass combustion residues composition to provide, including the inevitable impurities, 100 wt. %. The inevitable impurities are, generally, unavoidable and are often a result of the process environment or feedstocks. Inevitable impurities may be present from 0.01 to 10.0 wt. % of the composition.

Asbestos has been widely used as an industrial insulant. However, the crystallographic structure of this material is highly hazardous, as it consists in micrometric fibers that can penetrate deeply into someone's lungs when broken or cut. Most countries prohibited its use and enacted legislation to safely dispose of this material. Aside landfilling on specialized sites, inertization through smelting/vitrification techniques have been developed. Asbestos-containing wastes are smelted in crucibles or with plasma torch technology, then casted, cooled down and crushed. The resulting gravel being a non-hazardous waste, it is usually landfilled or used as road sub-base or filler. This material comprises, and preferably consists essentially of:
aluminum oxide (Al₂O₃): from 2 to 10 wt. %,
calcium oxide (CaO): from 25 to 50 wt. %.
iron oxide (Fe₂O₃): from 0 to 5 wt. %,
magnesium oxide (MgO): from 4 to 15 wt. %,
silicon dioxide (SiO₂): from 35 to 55 wt. %,
optionally one or more of the following: from 0.01 to 10 wt. %.
MnO, K₂O, Na₂O, and TiO₂
   and inevitable impurities, wherein the wt. % is the weight percent relative to the total weight of the asbestos inertization residues composition to provide, including the inevitable impurities, 100 wt. %. The inevitable impurities are, generally, unavoidable and are often a result of the process environment or feedstocks. Inevitable impurities may be present from 0.01 to 10.0 wt. % of the composition.

Rock dusts are mostly produced by the mining and quarrying industries, as a by-product of rock extraction, polishing or crushing. They are also widely available in the environment. Although they might be used as concrete filler or road sub-base material, increasing their use in higher added-value applications in the ceramic field could be beneficial. Their composition can vary widely depending on geographical location and the nature of the rocks presents and can contain various amount of oxides such as Fe₂O₃, Al₂O₃, etc. These materials comprise, and preferably consists essentially of:
aluminum oxide (Al₂O₃): from 3 to 14 wt. %,
calcium oxide (CaO): from 0.1 to 20 wt. %.
iron oxide (Fe₂O₃): from 0.01 to 8 wt. %.
magnesium oxide (MgO): from 0.01 to 6 wt. %,
silicon dioxide (SiO₂): from 60 to 88 wt. %,
sodium oxide (Na₂O): from 0.01 to 3 wt. %,
potassium oxide (K₂O): from 0.5 to 6 wt. %,
optionally one or more of the following: from 0.01 to 10 wt. %.
MnO, P₂O₅, SOx, and TiO₂
   and inevitable impurities, wherein the wt. % is the weight percent relative to the total weight of the rock dusts, sand and tailings composition to provide, including the inevitable impurities, 100 wt. %. The inevitable impurities are, generally, unavoidable and are often a result of the process environment or feedstocks. Inevitable impurities may be present from 0.01 to 10.0 wt. % of the composition.

Sand is basically made of natural unconsolidated granular materials. Sand is composed of sand grains which range in size from 0.06 to 2 mm. Sand grains are either rock fragments, mineral particles, or oceanic materials in origin. They are widely available in the environment. The most common mineral in the sand is quartz—also known as silicon dioxide. Also, sand can be recycled sand. Recycled sand are materials derived from industry (foundry sand being a typical example), construction, demolition and excavation activities which are reprocessed and/or re-used whenever possible. These materials comprise, and preferably consists essentially of:
aluminum oxide (Al₂O₃): from 0.1 to 5 wt. %,
calcium oxide (CaO): from 0.1 to 6 wt. %,
iron oxide (Fe₂O₃): from 0.01 to 5 wt. %,
magnesium oxide (MgO): from 0.01 to 6 wt. %.
silicon dioxide (SiO₂): from 75 to 99 wt. %,
sodium oxide (Na₂O): from 0.01 to 3 wt. %,
potassium oxide (K₂O): from 0.5 to 4 wt. %,
optionally one or more of the following; from 0.01 to 10 wt. %.
MnO, P₂O₅, SOx, and TiO₂
   and inevitable impurities, wherein the wt. % is the weight percent relative to the total weight of the sand composition to provide, including the inevitable impurities, 100 wt. %. The inevitable impurities are, generally, unavoidable and are often a result of the process environment or feedstocks. Inevitable impurities may be present from 0.01 to 10.0 wt. % of the composition.

A fraction of a ceramic factory's production is damaged during firing, for a variety of reasons, and can therefore not be sold. It is common practice in some ceramic industries (especially the brick and tiles industry) to mill a portion of these discarded items and integrate the powder into their feedstock, as a de-greasing and reinforcing agent, substituting sand. However, this valorization pathway is not always sufficient or even possible, and fired ceramic materials are landfilled or used in low added-value applications (filler . . . ). Moreover, used ceramics are produced by heavy industries and the demolition sectors (damaged refractory bricks, broken tiles . . . ) and might be better used. All of these different materials will be thereafter regrouped under the general term “fired ceramic materials”. Their chemical composition will be similar to the clays and clay-like materials, as these are the base materials used for the most part of ceramic production. Moreover, some ceramic products are polished to obtain specific surface and aesthetic properties, or rectified (cut). As ceramics are hard and durable materials, specialized machinery is used for these operations, under water and lubricant spraying. The mixture obtained is referred to as “polishing mud” or “polishing dust” depending on its water content, and is one of the disclosed invention's possible feedstock. Used ceramics may include but are not limited to: building bricks, tiles and slabs, alimentary or technical porcelains, stoneware and earthenware.

The ceramic formation will contain always some weight percent of refractory wastes. Refractory wastes are produced as by-products of industrial processes (e.g., steel, cement, glass, ceramic industries) or as by-products of refractory industries. In the former case, this refers to refractory materials that have been used, and are discarded after their service life (spent refractories). The latter case refers to refractory wastes produced during the manufacturing of refractory products (e.g., off-specs pieces, dusts and defective pieces, cutting residues). Many different families of refractory ceramics exist, and can be used to produce the ceramic tiles. These families are described thereafter: (1) Silica refractory waste, (2) High Alumina refractory waste, (3) Magnesite refractory waste, (4) Forsterite refractory waste, (5) Dolomite refractory waste, (6) Magnesia chrome refractory waste, (7) Magnesia carbon refractory waste, (8) Zirconia refractory waste. (9) AZS refractory waste, and (10) Insulating or fireclay refractory waste.

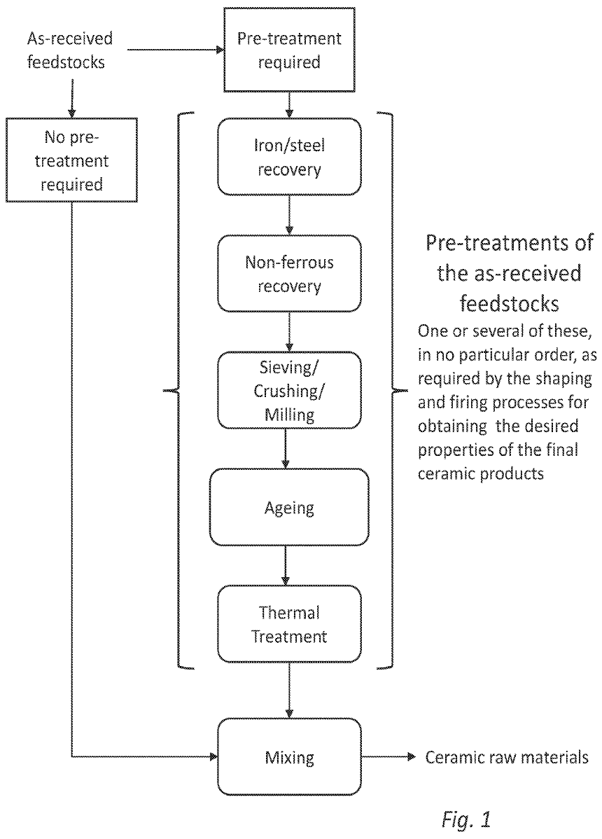

Pre-treatments, illustrated in flow chart of FIG. 1, is a general term regrouping process steps that are done prior to using the as-received material, generally to make the material more compatible with the requirements of the transformation process (i.e.: mixing, shaping, firing a ceramic), or to make the material easier to handle, store, and transport.

The presence of metals into a ceramic raw material can be detrimental, as metals can be reactive at high temperatures (oxidation or reduction, as an example). Moreover, their thermal dilatation coefficient being generally higher than the other constituents of a ceramic matrix surrounding them (alumino-silicates, alumina, zirconia, magnesia . . . ), they tend to fracture the matrix or produce cavities in the bulk of a green body during firing. Hence, iron and steel recovery from the feedstock could be advised (especially for highly contaminated materials for which the metal content represents an economic opportunity). Iron and steel recovery processes are widespread and rely on the generation of a strong magnetic current over a conveyor. Iron-rich particles will be attracted by the magnet, and be removed from the feedstock. This process is widely used on MSWIBA, and household wastes.

Non-ferrous metals recovery also generally relies on the generation of a strong, varying magnetic field, called Eddy Current or Foucault Current. Metals react differently to this magnetic field: ferrous metals are attracted to it, while non-ferrous metals (aluminum and copper) are repulsed. By exposing the feedstock (on a conveyor, for example) not only the metals can be extracted from it, but also sorted. This process is widely used in waste-sorting facilities, typically to recover aluminum cans and copper wires from household wastes.

The as-received feedstocks, which exhibit a particle size (longest linear dimension) of 50 mm or less, are subjected to a milling or crushing process. Crushing consist in destroying a material by overwhelming compressive force or mechanical shock, allowing to transform a granular material into a finer one. However, the crushed material will most often present itself with a strongly heterogeneous shape. One of the most common crushing devices is called a jaw crusher. It is commonly used by the mineral industries (mining, quarrying, ceramic industries . . . ) to transform rocks into a workable gravel that can either be used as it is (ballast, filler, concrete rock agglomerate) or undergo further treatments such as milling. The particles feedstocks are preferably reduced to a powder size of 1 mm or less, wherein the size is the longest linear dimension of the powders. When using a commercial jaw crusher, the particles are preferably crushed for a period of time in the range of 0.2 hours to 4 hours including all values and ranges therein. After that, milling processes are used to produce particles with more homogeneous shape and roundness. Milling, also called grinding, rely more on attrition than on shock or compression to reduce particle size. Mills also are more prevalent for reducing particles to a smaller size than crushers. Depending on the grinding media and operational parameters, they can produce millimetric, micrometric, and sub-micronic powders. Ball millers are commonly used to grind clinker in cement industries, mineral ore in mining industries, or to produce fine et homogeneous powders or slurries for the ceramic industries (in the latter case, it is common practice to mill the materials diluted in water, sometimes with dispersant additives). The particles are preferably reduced to a powder size of 300 μm of less, wherein the size is the longest linear dimension of the powders. When using a commercial ball mill, the particles are preferably milled for a period of time in the range of 0.2 hours to 4 hours including all values and ranges therein.

Sieving consist in passing a granular material through a sieve with a fixed mesh. The particles smaller than the sieve gap will pass through, while wider ones will be retained at the surface of the mesh. It is common practice to use sieves in series, to retain certain fractions of a granular material. The crushed or milled powder is then sieved to obtain a homogenous mixture with particles sizes between 10 μm to 2 mm, including all values and ranges therein. Preferably for the ceramic's feedstocks mixing, the powders are screened to a size in the range of 20 to 400 μm.

Ageing is a process used to stabilize materials that are not ready to be used at a given time. For example, MSWIBA, when exiting the incineration chamber, can be rich in alkali oxides and hydroxides (i.e., CaO and Ca(OH)₂), those species being reactive and potentially detrimental for a given valorization path. Ageing, sometimes also called weathering, consists in exposing the material to the elements (air, rain, sun, etc.) for a given period of time between 4 to 20 weeks, including all values and range therein, in order to stabilize it through metal's oxidation, organic matter decay, and carbonation.

Thermal treatment is another way to prepare a material for valorization. It consists in heating the said material, generally under atmospheric conditions, and can pursue several goals: destroying organic matter through combustion, oxidizing metals, drying or deep-drying of the material (including pore water or crystal hydration water), removing hydroxyl groups (—OH), removing carbonates (—CO₃), and eventually removing sulfur compounds (S, —SOx). Such treatment can have a considerable influence on the material's behavior. The thermal treatment is operated between 100 to 1200° C., including all values and ranges therein. As an example, removing all moisture from a powder can vastly help mixing it with other dry powders, and improve the granulation behavior under sprayed water. Removing organic matter, sulfur and carbonates prevent them from venting during the ceramic sintering process, which can have a highly detrimental impact on properties (density, mechanical strength, surface properties, and aesthetic properties).

The disclosed ceramics are produced based on several materials and feedstocks formulation that need to be mixed together prior to shaping. The feedstocks present themselves either as loose, dry powders or agglomerates, as a paste, or as a slurry. Depending on their properties, they will be mixed using rotary drums, rotary plates, pug mills, or any kind of mixer appropriate to their properties, according to the mixing ratios chosen for a particular application of the final ceramic. Preferably, the finest powders will be added first into the mix. Added water, if any, should be added progressively into the mixture, preferably by spraying during mixing. The goal of this process step is to produce a homogeneous mixture that can then be used as the raw ceramic material in the shaping step.

Shaping method consists in forming the raw ceramic materials to obtain a final product. The disclosed ceramic materials can be formed using two different methods, depending on the type of application for the desired ceramic, as well as the nature of the raw ceramic material. At this stage, the term “raw ceramic material” designates a homogeneous mixture of powders or a paste formed of the several feedstocks chosen. The present invention further related to two different methods of forming the final products: (i) extrusion, (ii) powder compaction process.

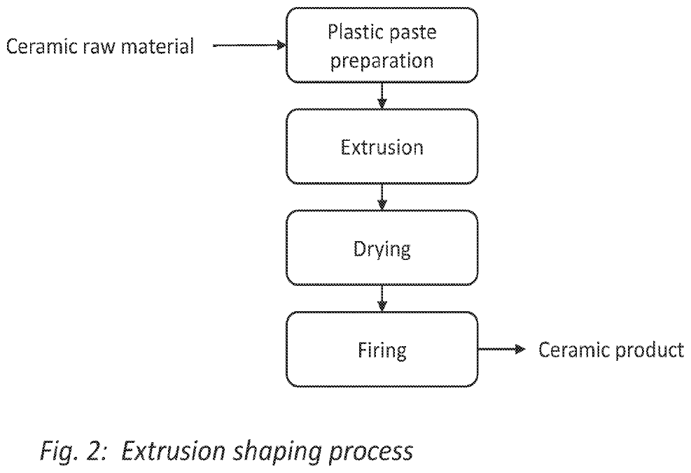

Preferably, a multi-step method for the extrusion method, illustrated in flow chart of FIG. 2, is used to form a structural ceramic described herein, the method embodying: (1) preparation the ceramic raw material to obtain a plastic paste, then (2) shaping by extrusion to obtain a solid called green body, then (3) drying to remove the moisture content, and finally (4) firing at high temperature to get a ceramic product. This forming method is commonly used to process clay-containing raw ceramic materials to produce roof and floor tiles, decorative and protective claddings, as well as a variety of specialty ceramics.

The aforementioned ceramic raw materials present themselves as a mixture of powders or as a paste. The extrusion shaping method requiring a certain level of plasticity, adjusting the water content of the raw materials can be needed (this is especially relevant for clay-rich formulations, as moisture greatly impacts clay's behavior). At this stage of the process, additives can also be added to the mix. The function of the additives might be to increase plasticity (i.e., plasticizers), reduce friction inside the extruder (i.e., lubricants and release agents) or modify the behavior of the green body during firing (i.e., fluxing agents). The different raw materials and water are mixed and grinded together in a ball mill with grinding media in the mill. Then a known quantity of water and a low percentage of deflocculants (if needed) are added in order to allow a better flowing of the slurry, also called slip. The produced slip guarantees a perfect mix between the different components. The slip is then pumped into a mechanical (like filter press) or thermal (like spray-drier) process to reduce the moisture. The mixture or cake also obtained will have a residual humidity about 10 wt. % to 20 wt. %. The cake are transferred to pug mills (with or without vacuum pump) through circular mixer (cake shredder). Usually, plastic pastes contain in the range of 10 wt. % to 30 wt. % water of the total weight of the formulation. Combined additives (plasticizers, temporary binders and lubricants, etc. . . . ) can be add in the circular mixer in an amount within a range from 0 wt. % to 3 t % of the total weight of the formulation. The pugmill improves the homogeneity of a plastic paste giving it greater workability.

At this point, the plastic paste is ready for extrusion. The prepared plastic paste is fed into the extruder's hopper, and pushed through the extruder's cylinder with either a ram, an endless screw or two parallel screws. Preferably, the extruder will be equipped with a vacuum pump, as the air trapped into the paste could adversely affect the properties of the extruded green body. The rotation speed of the screw or ram speed are to be adjusted depending on the properties of the paste and the desired output rate and is from 10 to 100 min⁻¹, including all values and ranges therein. Extruders can be equipped with a variety of auxiliary systems, including but not limited to spray outlets inside the cylinder to dispense lubricants and release agents, heating systems, cooling systems, pressure sensors, temperature sensors. The extruded product has a moisture content (water content) of 14 to 18 wt. % which is ideal for punching (cutting). Flat punched tiles are punched from a flat plastic-extruded continuous clay column and then cut into a required sizes either using fixed cutting knives or by performing sequential cutting or punching system.

After the extrusion and punching, drying operation is done to the green body using purpose-built dryers, with monitored humidity. During the drying stage, in which the temperature is transitioned from room temperature (20 to 30° C.) to drying temperature in the range of 200° C. to 300° C., including all values and ranges therein. The conventional time of the drying stage is preferably between 0.25 to 72 hours, including all values and ranges therein, depending on the size of the green body and its moisture content. The purpose-built dryers could be closed or tunnel ovens.

After drying, the ceramic product can either be pushed to the glazing line or directly to the firing line (unglazed tiles). Glazes, a slurry applied on the top of the ceramic body, are responsible for the glassy surface on the surface of a tile that give it its final color and finish, though depending on the opacity of the glaze, the color of the clay itself may show up through the glaze. Glaze is made up of a number of minerals and metals that define color, opacity, and finish. It is the result of a chemical interaction between these mineral ingredients, where each ingredient undergoes a molecular reaction under high heat. The result will not only be a function of glaze composition and firing temperature, but also on the nature of the firing environment (oxygen-rich or oxygen-depleted). Glazes can be applied either on a green body (single-fired glazed tiles) or on an already fired ceramic. If the ceramic body was fired, a second firing operation is required (double-fired glazed tiles).

After the drying, firing operation is performed to allow sintering and obtain a ceramic product. The firing temperature is selected depending on the shape, the thickness and the formulation (including the glaze's), it will be comprised between 800 and 1400° C. More preferably, the firing temperature will be comprised between 1100 and 1250′° C. If the purpose-built firer is a tunnel furnace/kiln (continuous firing), the firing cycle, from cold to cold, is in the range of 0.5 hours to 3 hours, including all values and ranges therein, with slow cooling curve depending of the thickness of the product. If the purpose-built firer is a muffle furnace/kiln (batch firing), the firing cycle, from cold to cold is in the range of 0.5 hours to 12 hours, including all values and ranges therein.

Various process parameters in the extrusion method may affect the properties of the final ceramic, such parameters might include the formulation, screw speed, de-airing, preheating temperature and duration, heating rate, firing temperature and duration, and product shape.

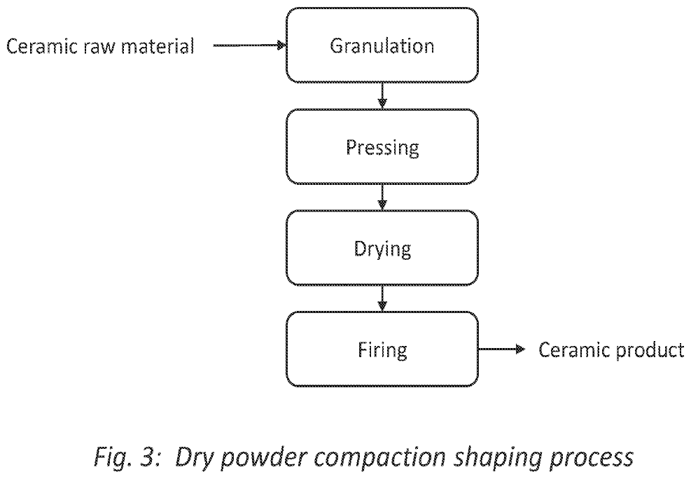

Preferably, a multi-step method for the powder compaction method, illustrated inflow chart of FIG. 3, is used to form structural ceramics described herein, the method embodying: (1) preparation of the ceramic raw material called granulation, then (2) pressing to obtain a solid called green compact, then (3) drying to remove the moisture content, and finally (4) firing at high temperature to get a ceramic product. This forming method is used to process raw ceramic materials to produce building bricks, roof and floor tiles, decorative and protective claddings. Contrary to the extrusion shaping method, the pressing method is less depending on plasticity, making it sometimes a preferable choice to shape raw ceramics materials with low clay content, or with clay with low workability.

The aforementioned ceramics raw materials present themselves as a mixture of powders, as a paste or as a slurry. Although the pressing methods can be less demanding than the extrusion regarding plasticity and cohesion, adjusting the water content of the raw materials can be needed. At this stage of the process, additives can also be added to the mix. The function of the additives might be to increase plasticity (i.e., plasticizers) or cohesion between particles (temporary binders), reduce friction inside the pressing mold (i.e., lubricants and release agents) or modify the behavior of the green body during firing (i.e., fluxing agents). Preferably, the resulting mixture will have lower moisture than the ones prepared for extrusion. The mixture can be dry or wet before to granulate the material. For the dry powder mixture, the different raw materials are mixed and grinded together in a ball mill with grinding media in the mill. Granulation can be done using different methods like rotary plate or drum moisturizing, by raising moisture slightly. The movement, as well as the change in moisture, cause particles to agglomerate to form small granules. For the wet powder mixture, the different raw materials and water are mixed and grinded together in a ball mill with grinding media in the mill. Then a known quantity of water and a low percentage of deflocculants (if needed) are added in order to allow better flowing of the slurry, also called slip. The produced slip guarantees a perfect mix between the different components. The slip is then pumped into a thermal process (spray-drier) to granulate and reduce the moisture. The size of the desired granules, the duration of the process and the water content needed vastly depends on the raw material's nature, the size of the desired green body and the desired properties for the final ceramic. Usually, granules contain in the range of 2 wt. % to 10 wt. % water of the total weight of the formulation, and if needed combined additives (plasticizers, temporary binders and lubricants, dispersants, flocculants, anti-foaming agents . . . ) are present in an amount within a range from 0 wt. % to 3 wt. % of the total weight of the formulation.

The pressing step consists in applying high pressure on the granules placed in a mold at room temperature, which is in turn placed into a press. The pressing action is uniaxial (i.e., the force is applied on a given direction). Preferably, the compressing pressure for the powder compaction falls in a range from 2 MPa to 100 MPa, including all values and range therein, and preferably 15 MPa to 50 MPa. Pressure should be preferentially applied at a steady rate, although it might be possible to hold pressure at low compaction pressure to allow eventual trapped air to vent out of the mold and allow the powder to reorganize.

After the powder compaction, drying operation is done to the green body using purpose-built dryers, with monitored humidity. During the drying stage, in which the temperature is transitioned from room temperature (20 to 30° C.) to drying temperature in the range of 100° C. to 300° C., including all values and ranges therein. The time of the drying stage is preferably between 0.25 to 72 hours, including all values and ranges therein, depending on the size and the thickness of the green body and its moisture content. The purpose-built dryers could be closed or tunnel ovens.

After drying, the ceramic product can either be pushed to the glazing line or directly to the firing line (unglazed tiles). Glazes, a slurry applied on the top of the ceramic body, are responsible for the glassy surface on the surface of a tile that give it its final color and finish, though depending on the opacity of the glaze, the color of the clay itself may show up through the glaze. Glaze is made up of a number of minerals and metals that define color, opacity, and finish. It is the result of a chemical interaction between these mineral ingredients, where each ingredient undergoes a molecular reaction under high heat. The result will not only be a function of glaze composition and firing temperature, but also on the nature of the firing environment (oxygen-rich or oxygen-depleted). Glazes can be applied either on a green body (single-fired glazed tiles) or on an already fired ceramic. If the ceramic body was fired, a second firing operation is required (double-fired glazed tiles).

After the drying, firing operation is performed to allow sintering and obtain a ceramic product. The firing temperature is selected depending on the shape, the thickness and the formulation (including the glaze's), it will be comprised between 800 and 1400° C. More preferably, the firing temperature will be comprised between 1100 and 1250° C. If the purpose-built firer is a tunnel furnace/kiln (continuous firing), the firing cycle, from cold to cold, is in the range of 0.5 hours to 3 hours, including all values and ranges therein, with slow cooling curve depending of the thickness of the product. If the purpose-built firer is a muffle furnace/kiln (batch firing), the firing cycle, from cold to cold is in the range of 0.5 hours to 12 hours, including all values and ranges therein.

After drying, the ceramic product can either be pushed to the glazing line or directly to the firing line (unglazed tiles). Glazes, a slurry applied on the top of the ceramic body, are responsible for the glassy surface on the surface of a tile that give it its final color and finish, though depending on the opacity of the glaze, the color of the clay itself may show up through the glaze. Glaze is made up of a number of minerals and metals that define color, opacity, and finish. It is the result of a chemical interaction between these mineral ingredients, where each ingredient undergoes a molecular reaction under high heat. The result will not only be a function of glaze composition and firing temperature, but also on the nature of the firing environment (oxygen-rich or oxygen-depleted). Glazes can be applied either on a green body (single-fired glazed tiles) or on an already fired ceramic. If the ceramic body was fired, a second firing operation is required (double-fired glazed tiles).

Various process parameters in the dry powder compaction method may affect the properties of the final ceramic, such parameters might include the formulation, compaction pressure, preheating temperature and duration, heating rate, firing temperature and duration, and product shape.

### Experimental Example #1

### Powder Compaction: URCM (80 wt. %), and Refractory Waste (20 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

A refractory waste has been collected as production waste of a refractory recycling factory. The powder presented itself as a very thin, homogeneous white powder, with a particle size below 180 μm.

The dry powders were mixed according to this specific composition: 80 wt. % of URCM, and 20 wt. % of refractory waste.

The dry mixtures have been mixed in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1225° C. with a total firing duration, from cold to cold, of 45 minutes.

The final product is a strong white ceramic surface, with a CIELAB color space: Lab(68.88, 1.74, 10.72). The water absorption is 0.01 wt. %, according to the Standard Test Method BS EN ISO 10545-3. The Modulus of Rupture (MOR) is 50.09 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #2

### Powder Compaction: URCM (70 wt. %), and Fired Ceramic Material (30 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

A fired ceramic material (type broken tiles) has been collected as production waste of a ceramic tiles factory. The material was milled using a ball miller during 0.5 hour, and sieved using a set of sieves and a sieve shaker. The final powder presented itself as a white powder, with a particle size below 180 μm.

The dry powders were mixed according to this specific composition: 70 wt. % of URCM, and 30 wt. % of Fired Ceramic Material.

The dry mixtures have been mixed in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1225° C., with a total firing duration, from cold to cold, of 47 minutes.

The final product is a strong white ceramic surface. The water absorption is 0.01 wt. %, according to the Standard Test Method BS EN ISO 10545-3. The Modulus of Rupture (MOR) is 46.4 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #3 Powder Compaction: URCM (70 wt. %), Sand (20 wt. %), and Refractory waste (10 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

A refractory waste has been collected as production waste of a refractory recycling factory. The powder presented itself as a very thin, homogeneous white powder, with a particle size below 180 μm.

The dry powders were mixed according to this specific composition, 70 wt. % of URCM, 20 wt. % of sand, and 10 wt. % of refractory waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1225° C., with a total firing duration, from cold to cold, of 47 minutes.

The final product is a strong grey ceramic surface. The water absorption is 0.01 wt. %, according to the Standard Test Method BS EN ISO 10545-3. The Modulus of Rupture (MOR) is 42.86 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #4

### Powder Compaction: URCM (80 wt. %), Refractory Waste (15 wt. %), and Color Pigment (5 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt %, with a d₅₀ of around 10 μm. Further milling was considered unnecessary. This as-received powder was dried 24 hours at 120° C., and then de-agglomerated by friction.

A refractory waste has been collected as production waste of a refractory recycling factory. The powder presented itself as a very thin, homogeneous white powder, with a particle size below 180 μm.

Ceramic pigment has been bought from a specialized company. It presents itself as a fine, dry, homogeneous blue powder. The main components are Co—Al—Zn.

The dry powders were mixed according to this specific composition: 80 wt. % of URCM, 15 wt. % of refractory waste, and 5 wt. % of commercial ceramic pigment.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1225° C., with a total firing duration, from cold to cold, of 45 minutes.

The final product is a strong blue ceramic surface. The water absorption is 0.01 wt. %, according to the Standard Test Method BS EN ISO 10545-3. The Modulus of Rupture (MOR) is 61.74 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #5

### Powder Compaction: URCM (45 wt. %), Sand (20 wt. %), and Glass Waste (35 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

Glass waste has been crushed, washed and milled to form a homogeneous powder, with a maximum size of 250 μm.

The dry powders were mixed according to this specific composition: 45 wt. % of URCM, 20 wt. % of sand, and 35 wt. % of glass waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1130° C., with a total firing duration, from cold to cold, of 35 minutes.

The final product is a strong grey ceramic surface, with a CIELAB color space: Lab(55.51, 0.86, 2.66). The water absorption is 0.04 wt. %, according to the Standard Test Method BS EN ISO 10545-3. The Modulus of Rupture (MOR) is 59.31 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #6

### Powder Compaction: URCM (65 wt. %), Sand (15 wt. %), and Glass Waste (20 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

Glass waste has been crushed, washed and milled to form a homogeneous powder, with a maximum size of 250 μm.

The dry powders were mixed according to this specific composition: 65 wt. % of URCM, 15 wt. % of sand, and 20 wt. % of glass waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1130° C., with a total firing duration, from cold to cold, of 36 minutes.

The final product is a strong grey ceramic surface, with a CIELAB color space: Lab(66.38, 5.26, 10.07). The water absorption is 14.29 wt. %, according to the Standard Test Method BS EN ISO 10545-3. The Modulus of Rupture (MOR) is 32.71 N/mm², according to the Standard Test Method BS EN ISO 10545-4. Thanks to the water absorption (between 10 to 20 wt. %) and the mechanical resistance (average value exceeding 16 N/mm²), the final products could be considered as a ceramic tiles (BIII).

### Experimental Example #7

### Powder Compaction: URCM (70 wt. %), Fired Ceramic Material (15 wt. %), and Steelmaking Dusts (15 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

A fired ceramic material (type broken tiles) has been collected as production waste of a ceramic tiles factory. The material was milled using a ball miller during 0.5 hour, and sieved using a set of sieves and a sieve shaker. The final powder presented itself as a white powder, with a particle size below 180 μm.

Steelmaking dusts (EAF dust), has been collected as a dark-brown, fine homogeneous powder, with small lumps of debris inside. The fraction passing a 180 μm sieve has been selected.

The dry powders were mixed according to this specific composition: 70 wt. % of URCM, 15 wt. % of Fired Ceramic Material, and 15 wt. % of Steelmaking dusts.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1160° C., with a total firing duration, from cold to cold, of 35 minutes.

The final product is a strong brown ceramic surface, with a CIELAB color space: Lab(31.05, 2.67, 8.73). The water absorption is 0.2 wt. %, according to the Standard Test Method BS EN ISO 10545-3. The Modulus of Rupture (MOR) is 52.18 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #8

### Powder Compaction: URCM (80 wt. %), Refractory Waste (15 wt. %), and Steelmaking Dusts (5 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 w. %, with a d₅₀ of around 10 μm. Further milling was considered unnecessary. This as-received powder was dried 24 hours at 120° C., and then de-agglomerated by friction.

A refractory waste has been collected as production waste of a refractory recycling factory. The powder presented itself as a very thin, homogeneous white powder, with a particle size below 180 μm.

Steelmaking dusts (EAF dust), has been collected as a dark-brown, fine homogeneous powder, with small lumps of debris inside. The fraction passing a 180 μm sieve has been selected.

The dry powders were mixed according to this specific composition: 80 wt. % of URCM, 15 wt. % of Refractory Waste, and 5 wt. % of Steelmaking dusts.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1150° C., with a total firing duration, from cold to cold, of 38 minutes.

The final product is a strong brown ceramic surface. The water absorption is 11.57 w. %, according to the Standard Test Method BS EN ISO 10545-3. The Modulus of Rupture (MOR) is 24.61 N/mm², according to the Standard Test Method BS EN ISO 105454. Thanks to the water absorption (between 10 to 20 wt. %) and the mechanical resistance (average value exceeding 16 N/mm²), the final products could be considered as a ceramic tiles (BIII).

### Experimental Example #9

### Powder Compaction: URCM (75 wt. %), Sand (10 wt. %), and MSWIBA (15 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

Municipal Solid Waste Incinerator Bottom Ash (MSWIBA) was collected as gravel between 0 mm to 40 mm and considered as post-treated gravel. Pre-treatment included: (1) crushing the raw MSWIBA from a range between 0 mm to 100 mm as coarse aggregate to a gravel using a jaw crusher with a range between 0 mm to 40 mm, then (2) magnetic removal of iron and steel, then (3) magnetic removal of non-ferrous metals and finally (4) ageing during 4 months. The moisture content of this material was around 7 wt. %. The MSWIBA was dried in an oven with forced air circulation at 120° C. during 12 hours, before being crushed, using a jaw crusher (Retsch BB 50) to obtain a powder in the range between 500 μm to 1 mm. The resulting powder was milled using a ball miller (Retsch PM 100) during 1 hour, and sieved using sieves and a sieve shaker. The final powder presented itself as a grey powder, with a particle distribution d₅₀ of 150 μm. The particle distribution d₅₀ is the diameter at which 50% of a sample's mass is comprised of smaller particles.

The dry powders were mixed according to this specific composition: 75 wt. % of URCM, 10 wt. % of Sand, and 15 wt. % of MSWIBA.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100-50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1120° C., with a total firing duration, from cold to cold, of 38 minutes.

The final product is a strong light brown ceramic surface. The water absorption is 15.40 wt. %, according to the Standard Test Method BS EN ISO 10545-3. The Modulus of Rupture (MOR) is 25.13 N/mm², according to the Standard Test Method BS EN ISO 10545-4. Thanks to the water absorption (between 10 to 20 wt. %) and the mechanical resistance (average value exceeding 16 N/mm²), the final products could be considered as a ceramic tiles (BIII).

### Experimental Example #10

### Powder Compaction. URCM (50 wt. %), Refractory Waste (15 wt. %), Steelmaking Dusts (5 wt. %), and Glass Waste (30 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

A refractory waste has been collected as production waste of a refractory recycling factory. The powder presented itself as a very thin, homogeneous white powder, with a particle size below 180 μm.

Steelmaking dusts (EAF dust), has been collected as a dark-brown, fine homogeneous powder, with small lumps of debris inside. The fraction passing a 180 μm sieve has been selected.

Glass waste has been crushed, washed and milled to form a homogeneous powder, with a maximum size of 250 μm.

The dry powders were mixed according to this specific composition: 50 wt. % of URCM, 15 wt. % of Refractory Waste, 5 wt. % of Steelmaking dusts, and 30 wt. % of Glass Waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1130° C., with a total firing duration, from cold to cold, of 43 minutes.

The final product is a strong brown ceramic surface. The water absorption is 5.81 wt. %, according to the Standard Test Method BS EN ISO 10545-3. The Modulus of Rupture (MOR) is 50.25 N/mm², according to the Standard Test Method BS EN ISO 10545-4. Thanks to the water absorption (between 3 to 6 wt. %) and the mechanical resistance (average value exceeding 22 N/mm²), the final products could be considered as a gres tiles (BIIA).

### Experimental Example #11

### Powder Compaction: URCM (45 wt. %), Sand (15 wt. %), Steelmaking Dusts (15 wt. %), and Glass Waste (25 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

Steelmaking dusts (EAF dust), has been collected as a dark-brown, fine homogeneous powder, with small lumps of debris inside. The fraction passing a 180 μm sieve has been selected.

Glass waste has been crushed, washed and milled to form a homogeneous powder, with a maximum size of 250 μm.

The dry powders were mixed according to this specific composition: 45 wt. % of URCM, 15 wt. % of Sand, 15 wt. % of Steelmaking dusts, and 25 wt. % of Glass Waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1130° C., with a total firing duration, from cold to cold, of 35 minutes.

The final product is a strong brown ceramic surface, with a CIELAB color space: Lab(32.48, 2.09, 5.71). The water absorption is 0.36 wt. %, according to the Standard Test Method BS EN ISO 10545-3. The Modulus of Rupture (MOR) is 47.08 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

### Experimental Example #12

### Powder Compaction. URCM (57 wt. %), Fired Ceramic Material (20 wt. %), Glass Waste (20 wt. %), and Color Pigment (3 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

A fired ceramic material (type broken tiles) has been collected as production waste of a ceramic tiles factory. The material was milled using a ball miller during 0.5 hour, and sieved using a set of sieves and a sieve shaker. The final powder presented itself as a white powder, with a particle size below 180 μm.

Glass waste has been crushed, washed and milled to form a homogeneous powder, with a maximum size of 250 μm.

Ceramic pigment has been bought from a specialized company. It presents itself as a fine, dry, homogeneous green powder. The main components are Cr—Al.

The dry powders were mixed according to this specific composition: 57 wt. % of URCM, 20 wt. % of Fired Ceramic Material, 20 wt. % of Glass Waste, and 3 wt. % of commercial ceramic pigment.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were fired in a tunnel oven. The maximum firing temperature was 1120° C., with a total firing duration, from cold to cold, of 38 minutes.

The final product is a strong green ceramic surface. The water absorption is 15.40 w. %, according to the Standard Test Method BS EN ISO 10545-3. The Modulus of Rupture (MOR) is 24.8 N/mm², according to the Standard Test Method BS EN ISO 10545-4. Thanks to the water absorption (between 10 to 20 wt. %) and the mechanical resistance (average value exceeding 16 N/mm²), the final products could be considered as a ceramic tiles (BIII).

### Experimental Example #13

### Powder Compaction: URCM (35 wt. %), Sand (15 wt. %), Glass Waste (35 wt. %), and Refractory Wastes (15 wt. %)

A URCM (waste clay), produced as a washing mud in a ceramic factory, was collected in a ceramic Effluent Treatment Plant (ETP). Mostly composed of a mixture of clay and feldspath mixed with glaze residues, it presented itself as a thick, white/grey mud constituted of fine particles, with residual water content between 15 to 30 wt. %, with a d₅₀ of around 10 μm. Further milling was considered unnecessary. This as-received powder was dried 24 hours at 120° C., and then de-agglomerated by friction.

Silica Sand has been bought from a sand company. It presents itself as a fine, dry, homogeneous powder with a maximum size of 250 μm.

Glass waste has been crushed, washed and milled to form a homogeneous powder, with a maximum size of 250 μm.

Refractory waste (Corundum/Chromium), has been collected as a dark-green, sand-like aggregate. After fine milling, the fraction passing a 63 μm sieve has been selected.

The dry powders were mixed according to this specific composition: 35 wt. % of URCM, 15 wt. % of sand, 35 wt. % of glass waste, and 15 wt. % of refractory waste.

The dry mixtures have been mixed together in a ball mill with water, and then spray-dried to form granules. The produced granules had a characteristic length in the range from 0.5 mm to 1 mm, and presented a moisture content of about 5 wt. %.

The granules were used to feed a rectangular mold (dimension: 100×50×5 mm), which was then pressed to form the green bodies. The applied pressure was 40 MPa using a uniaxial hydraulic press. Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies have then been dried in a tunnel oven at 160° C. for 15 min. The dried bodies were and fired in a tunnel oven. The maximum firing temperature was 1130° C., with a total firing duration, from cold to cold, of 35 minutes.

The final product is a strong green ceramic surface, with a CIELAB color space: Lab(40.28, −4.52, 7.67). The water absorption is 0.31 wt. %, according to the Standard Test Method BS EN ISO 10545-3. The Modulus of Rupture (MOR) is 61.81 N/mm², according to the Standard Test Method BS EN ISO 10545-4. Thanks to the water absorption (lower than 0.5 wt. %) and the mechanical resistance (average value exceeding 35 N/mm²), the final products could be considered as a porcelain tiles (BIA).

1. A method of producing a ceramic product comprising:
pretreating the feedstock from at least of iron/steel recovery, recovery of at least one non-ferrous material, sieving, crushing, milling, aging, and thermal treatment;
receiving as a first powder a first recovered material from the pretreating;
receiving as a second powder a second recovered material from the pretreating;
combining the first and second powders with water to form at least one of an extrudable paste and a granulated mixture;
forming a green body from the at least one of the extrudable paste after extrusion and the granulated mixture;
drying the green body;
firing the green body to form the ceramic product; and
cooling the ceramic product.

2. The method as claimed in claim 1, wherein the first powder is Unfired Raw Ceramic Material (UCRM) powder, and wherein the second powder is at least one of the feedstock included in the following list: Fired Ceramic Materials, Sand, Rock Dusts, Asbestos-containing wastes, and Refractory Wastes.

3. The method as claimed in claim 2, wherein the first powder is at least 30% by weight of the first and second powders.

4. The method as claimed in claim 2, wherein the second powder is at least 5% by weight of the first and second powders.

5. The method as claimed in claim 2, wherein the first powder is 80% by weight of the first and second powders, and
wherein the second powder is refractory waste, and amounts to 20% by weight of the first and second powders, each with weight variations of +/−5 percent of those weights.

6. The method as claimed in claim 2, wherein the first powder is 70% by weight of the first and second powders, and
wherein the second powder is a mix between refractory waste and sand, with a relative weights of 10, and 20% respectively, each with weight variations of +/−5 percent of those weights.

7. The method as claimed in claim 2, wherein combining the first and second powders further comprises combining a third powder to form the at least one of the extrudable paste and the granulated mixture, wherein the third powder is at least one of the feedstock included in the following list: MSWIBA, MSWIFA, Glass Waste, Alumina Red Mud, Aluminum Dross, Steelmaking dusts and Biomass Ash.

8. The method as claimed in claim 7, wherein the third powder is at most 40% by weight of the first second, and third powders.

9. The method as claimed in claim 7, wherein the second powder is sand, and third powder is glass waste, and
wherein the first, second and third powders have relative weights of 65%, 15% and 20% respectively, each with weight variations of +/−5 percent of those weights.

10. The method as claimed in claim 7, wherein the second powder is sand, and third powder is glass waste, and
wherein the first, second and third powders have relative weights of 45%, 20% and 35% respectively, each with weight variations of +/−5 percent of those weights.

11. The method as claimed in claim 7, wherein the second powder is refractory waste, and third powder is steelmaking dust and
wherein the first second and third powders have relative weights of 80%, 15% and 5% respectively, each with weight variations of +/−5 percent of those weights.

12. The method as claimed in claim 7, wherein the second powder is sand, and third powder is a mix between steelmaking dust and glass waste, and
wherein the first, second and third powders have relative weights of 50%, 15%, 5% and 30% respectively, each with weight variations of +/−5 percent of those weights.

13. The method as claimed in claim 2, wherein combining the first and second powders or the first second and third powders further comprises combining a fourth powder to form the at least one of the extrudable paste and the granulated mixture, wherein the fourth powder are a commercial ceramic pigment.

14. The method as claimed in claim 13, wherein the fourth powder has a relative weight of at most 5% with respect to the first through fourth powders.

15. The method as claimed in claim 13, wherein the second powder is Fired Ceramic Material, the third powder is glass waste and the fourth powder is commercial ceramic pigment, and
wherein the first second, third, and fourth powders have relative weights of 57%, 20%, 20% and 3% respectively, each with weight variations of +/−5 percent of those weights.

16. A ceramic, gres, or porcelain tiles produced according to claim 1.
